(19) United States
(12) Patent Application Publication
(10) Pub. No.: US 2009/0067025 A1
(43) Pub. Date: Mar. 12, 2009

(54) Method and System for Filling Voids in Electromechanical Systems

(75) Inventors: Earl Vedere Atnip, Plano, TX (US); Mark Andrew Franklin, Plano, TX (US); Gregory Dean Winterton, Flower Mound, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/852,629

(22) Filed: Sep. 10, 2007

(51) Int. Cl. G02B 26/08; B05D 5/06

(52) U.S. Cl. 359/224; 427/162

(57) ABSTRACT

In accordance with one embodiment of the present disclosure, a method for filling a void of an electromechanical system includes forming a void within a support layer. A conductive layer is formed outwardly from the support layer such that a portion of the conductive layer partially fills the void. A remainder of the void is filled with an inorganic material. A mirror is formed outwardly from the inorganic material and the conductive layer.

### TECHNICAL FIELD OF THE DISCLOSURE

This invention relates in general to electromechanical systems, and more particularly to a method and system for filling voids in electromechanical systems.

### BACKGROUND OF THE DISCLOSURE

Electromechanical systems often include support structures having micro-scale or nano-scale voids or vias disposed therein. These voids or vias may limit performance and reliability of some electromechanical systems for a variety of reasons. For example, some display systems make use of electromechanical micromirrors that are supported by hollow vias. Such hollow support vias may limit contrast and brightness of some display systems by limiting the micromirror reflective surface area and/or by causing stray reflections of incident light. One example device using deformable micromirrors is a DMD (digital micromirror device) made by Texas Instruments Inc.

### SUMMARY OF THE DISCLOSURE

In accordance with one embodiment of the present disclosure, a method for filling a void of an electromechanical system includes forming a void within a support layer. A conductive layer is formed outwardly from the support layer such that a portion of the conductive layer partially fills the void. A remainder of the void is filled with an inorganic material. A mirror is formed outwardly from the inorganic material and the conductive layer.

One advantage of some embodiments of the present disclosure is that voids in electromechanical systems are completely filled using a thermally-stable, self-planarizing, and/or photo-definable material, which may enhance performance and reliability of some electromechanical systems. Thermal stability, in particular, may minimize reliability concerns associated with outgassing and thermal expansion mismatches. In addition, filling voids may enhance structural rigidity.

Yet another advantage of some embodiments is the enablement of larger voids, or an increased number of voids. Larger voids can improve the step coverage, which, in the context of DMDs, can yield more reliable mirrors without compromising contrast ratio (due to the larger void surface area to mirror surface area ratio).

A further advantage, in some optical applications, is an increase in reflective surface area and reflective surface flatness of electromechanical structures, which may enhance brightness and contrast.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a perspective view of a portion of an example electromechanical system in accordance with one embodiment of the present disclosure;

FIG. 2A shows a cross-sectional view of a portion of the electromechanical system of FIG. 1 at point during its fabrication where it has a void;

FIG. 2B shows a cross-sectional view of a portion of the electromechanical system of FIG. 2A after filling the void with a void-filling layer;

FIG. 2C shows a cross-sectional view of a portion of the electromechanical system 100 of FIG. 2B after an optional partial removal of the void-filling layer; and

FIG. 2D shows a cross-sectional view of a portion of the electromechanical system of FIG. 2C after the formation of a capping layer outwardly from the void-filling layer.

### DETAILED DESCRIPTION OF THE DISCLOSURE

In accordance with the teachings of the present disclosure, a method and system for filling voids in electromechanical systems are provided. The method and system may be used in any of a variety of electromechanical systems, including, for example, spatial light modulators. An example of one such spatial light modulator is a deformable micromirror device, a subset of which includes a digital micromirror device (DMD). Particular examples and dimensions specified throughout this document are intended for example purposes only, and are not intended to limit the scope of the present disclosure. In particular, this document is not intended to be limited to a particular electromechanical system, such as, a DMD. Moreover, the illustrations in the FIGURES are not necessarily drawn to scale.

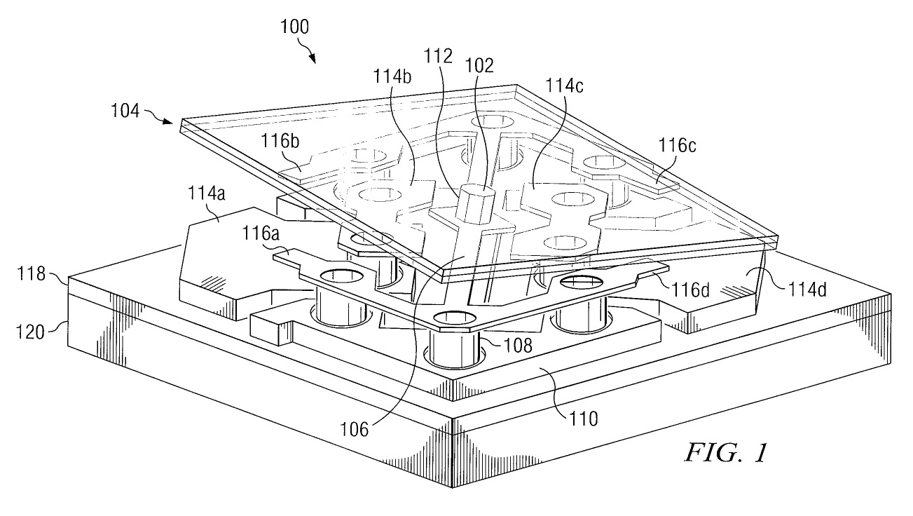

FIG. 1 is a perspective view of a portion of an example electromechanical system 100 having a filled void 102 that helps support a micromirror 104 in accordance with one embodiment of the present disclosure. In the illustrated embodiment, electromechanical system 100 includes an array of hundreds of thousands of micromirrors 104 that form a portion of a DMD; however, any suitable electromechanical system may be used.

Each micromirror 104 may tilt up to plus or minus twelve degrees, for example, creating an active “on” state condition or an active “off” state condition. Micromirrors 104 transition between active “on” and “off” states to selectively communicate at least a portion of an optical signal or light beam. To permit micromirrors 104 to tilt, each micromirror 104 is attached to a respective hinge 106 mounted between hinge posts 108, and spaced by means of an air gap over conductive conduits 110. A support post 112 couples each micromirror 104 to a respective hinge 106. In the example embodiment, support post 112 is filled with an inorganic material, as explained further below.

Micromirrors 104 transition between “on” and “off” state conditions as a result of preferential electrostatic forces between micromirror 104 and at least one of its corresponding electrodes 114. In this example, each micromirror 104 rotates until it compresses springtip pairs 114a,b and 114c,d anchored to the same layer as hinge 106. Although this example includes springtip pairs 114, other examples may control electromechanical motion using other suitable mechanisms. For example, alternative embodiments may include springtips coupled to a yoke (not explicitly shown) that pivots with hinge 106.

In this example, conductive conduits 110 are multi-layered, etched-metallic structures disposed outwardly from a dielectric layer 118. Dielectric layer 118 operates to isolate conductive conduits 110 from a substrate 120. Substrate 120 comprises the control circuitry associated with electromechanical system 100. The control circuitry may include any hardware, software, firmware, or combination thereof capable of at least partially contributing to the creation of the electrostatic forces between electrodes 114 and micromirrors 104. The control circuitry associated with substrate 120 functions to selectively transition micromirrors 104 between “on” state and “off” state based at least in part on data received from a processor (not explicitly shown).

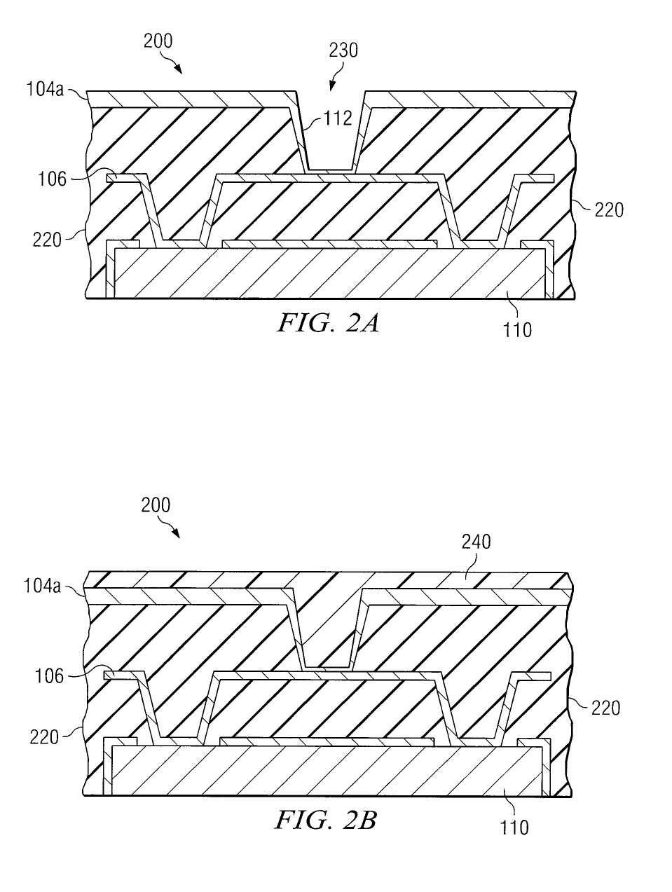

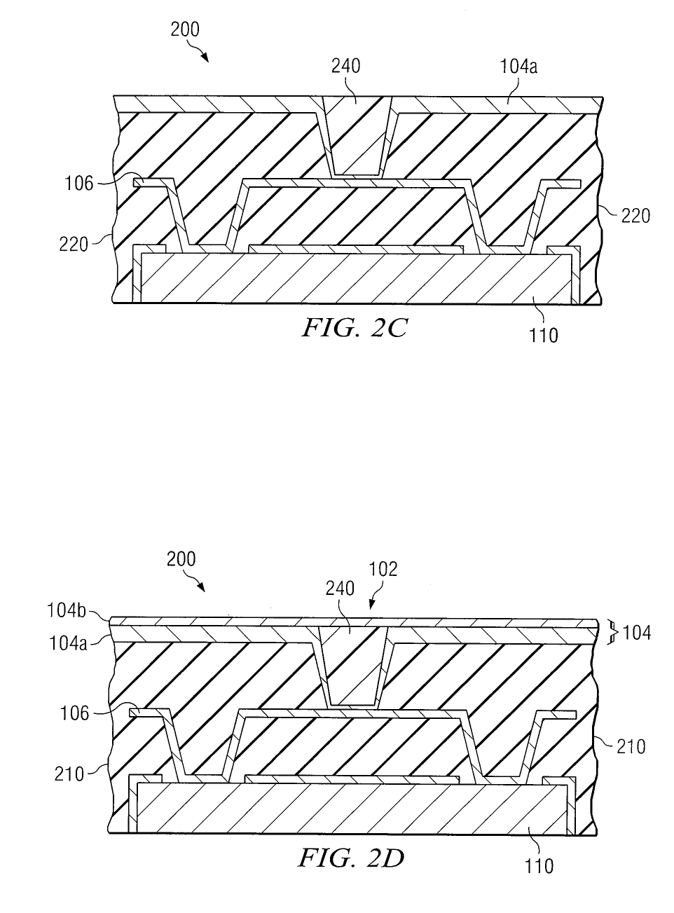

Voids within an electromechanical portion of a device may inhibit performance and reliability for a variety of reasons. For example, some DMDs have hollow mirror support posts that inhibit contrast, brightness, and structural rigidity. Accordingly, teachings of some embodiments of the present disclosure recognized methods for filling electromechanical voids using a thermally-stable, self-planarizing, and/or photo-definable material. Voids as used herein generally refers to any via, hole, gap, or opening defined by an electromechanical structure or layer. Example process steps associated with filling such voids are illustrated in FIGS. 2A through 2D in the context of a DMD having highly optically-efficient micromirrors 104 for use in display systems. The teachings of the present disclosure may be applied, however, to any of a variety of electromechanical systems having filled voids.

FIG. 2A shows a cross-sectional view of a portion of the electromechanical system 100 of FIG. 1 at a point during its fabrication where it has a void 230. In particular, FIG. 2A shows electromechanical system 100 after the formation of a conductive layer 104a outwardly from a sacrificial layer 220 and after the formation of support post 112 within sacrificial layer 220. At this point in the process, the inner sidewall of support post 112 defines void 230.

In the example embodiment, conductive layer 104a is formed by an anisotropic physical vapor deposition (PVD) of an aluminum alloy; however, any suitable material and/or process may be used. In this manner, conductive layer 104a and support post 112 are formed substantially simultaneously. Conductive layer 104a is sufficiently thick to ensure adequate conductive coupling to hinge 106, and typically makes up 40 to 60 percent of the overall desired micromirror 104 thickness. In the example embodiment, conductive layer 104a contributes to the electrostatic attraction of micromirror 104 to electrodes 114. In some alternative embodiments, however, layer 104a may be non-conductive.

Sacrificial layer 220 may comprise, for example, oxide, hardened photoresist, or any suitable material capable of forming a void therein. That is, portions of sacrificial layer 220 were previously removed in preparation for the formation of support posts 112. In the example embodiment, support posts 112 are positioned at the center of hinge 106 and are sufficiently large in size to enable secure attachment of micromirror 104 to hinge 106; however, any suitable number of support posts 112 may be formed any suitable location. For example, some alternative embodiments may use multiple support posts 112 located at positions other than the center of hinge 106.

In the example embodiment, sacrificial layer 220 spaces hinge 106 from conductive layer 104a by a distance of approximately 1 μm. At some point, sacrificial layer 220 is selectively removed so that micromirror 104 may pivot. The selective removal of sacrificial layer 220 may include any suitable process, such as, for example, a plasma-ash that does not significantly affect micromirror 104 and hinge 106.

FIG. 2B shows a cross-sectional view of a portion of the electromechanical system 100 of FIG. 2A after the formation of a void-filling layer 240 outwardly from conductive layer 104a. Although conductive layer 104a and void-filling layer 240 are shown as being formed without interstitial layers between them, such interstitial layers could alternatively be formed without departing from the scope of the present disclosure.

The material(s) used for void-filling layer 240 may be selected based on any of a variety of characteristics, including, for example, self-planarization, the ability to fill voids narrower than approximately 0.5 μm, thermal stability, minimal outgassing, low temperature curability, and/or low shrinkage. Self-planarization generally refers to the ability of a material to inherently form a substantially flat outer surface after applying the material. In the case of spin-on materials, the ability to fill smaller voids is typically dependent upon the viscosity of the material. Thermal stability generally refers to minimal expansion and contraction of a material due to temperature change. Minimal outgassing generally refers to the ability of a material to have minimal loss of gas phase bi-products due to evaporation decomposition, or other post-cure processes or reactions. Low temperature curability generally refers to the ability of a material to cure at temperatures below approximately 200° C. and/or have minimal chemical structural change at temperatures up to 400° C., post cure. Low shrinkage generally refers to minimal volume change of a material as a result of any curing processes.

Some void-filling layers 240 may have most, if not all, of the aforementioned material characteristics. For example, various embodiments may use inorganic materials for void-filling layer 240. An “inorganic material” as used herein generally refers to a chemical compound that is not an organic compound. An organic compound as used herein refers to compounds that contain hydrogen and carbon bonded to each other, such as, for example, various photoresists. Examples of inorganic material include non-metallic material(s), such as, silicon or silicon compounds; however, any suitable non-metallic, metallic and/or metalloid material(s) may be used.

In the example embodiment, void-filling layer 240 is an inorganic glass that is applied in liquid form to the center of a rotating wafer. In the context of some DMDs, such a spin-on void-filling layer 240 may adequately posses each of the aforementioned material characteristics. Void-filling layer 240 typically is applied with a thickness sufficient to at least fill the remainder of void 230, and may overfill void 230, as shown in FIG. 2B.

Some void-filling layers 240 may be patterned, cured, and developed after applied. The illustrated example uses a photosensitive glass that is cured at low-temperatures. In particular, void-filling layer 240 is exposed to a photo-initiator pattern and a curing temperature below approximately 200° C.; however, any suitable patterning and/or curing process may be used. The unwanted glass is then developed away. An optional removal of a portion of remaining void-filling layer 240 is illustrated in FIG. 2C.

FIG. 2C shows a cross-sectional view of a portion of the electromechanical system 100 of FIG. 2B after a partial removal of void-filling layer 240. In the example embodiment, an etch process that endpoints on conductive layer 104a leaves void-filling layer 240 only between the sidewalls of support structure 112; however, any suitable process may be used. For example, alternative embodiments may use a timed etch that leaves a portion of void-filling layer 240 disposed outside of support structure 112. This remaining portion may be used, for example, to partially planarize an otherwise imperfectly planar conductive layer 104a by filling in any outwardly disposed contours. In the example embodiment, the outer surface of void-filling layer 240 is substantially planar with the outer surface of conductive layer 104a. In this manner, the outermost surface of electromechanical system 100 is prepared for subsequent process layers. Various alternative embodiments, however, may not include the outwardly disposed layer(s) illustrated in FIG. 2D.

FIG. 2D shows a cross-sectional view of a portion of the electromechanical system 100 of FIG. 2C after the formation of a capping layer 104b outwardly from conductive layer 104a and void-filling layer 240. Although conductive layer 104a, void-filling layer 240, and capping layer 104b are shown as being formed without interstitial layers between them, such interstitial layers could alternatively be formed without departing from the scope of the present disclosure.

In the example embodiment, capping layer 104b is formed by an anisotropic physical vapor deposition (PVD) of an aluminum alloy; however, any suitable material and/or process may be used. Using the same or similar materials for conductive layer 104a and capping layer 104b may improve thermal matching, thereby enhancing reliability; however, conductive layer 104a and capping layer 104b may be formed from different materials.

In the context of DMDs, capping layer 104b forms the outer reflective surface of micromirrors 104. Capping layer 104b has a thickness, when combined with conductive layer 104a, which makes up the remaining percentage of the overall desired micromirror 104 thickness. Too great a thickness may change the moment of inertia for micromirror 104, thereby potentially hurting the performance of electromechanical system 100.

As shown in FIG. 2D, the formation of capping layer 104b outwardly from support structure 112 completely encapsulates void-filling layer 240. Some alternative embodiments, however, may not include the processes described with reference to FIG. 2C. In some such embodiments, the composition of micromirrors 104 outside support structure 112 may include an overfilled portion of void-filling layer 240 that spaces conductive layer 104a from capping layer 104b. In addition, some alternative embodiments may not include the processes described above with reference to FIG. 2D. For example, the outer surfaces of conductive layer 104a and/or void-filling layer 240 may be sufficiently reflective for some DMD applications.

The teachings of some embodiments of the present disclosure recognized certain advantages of using inorganic material(s) for void-filling layer 240 as opposed to organic material(s). For example, some organic materials, such as photoresists, may decompose and outgas when exposed to elevated temperatures. Such outgassing may compromise reliability. For example, the outgassing of void-filling layer 240 may decouple capping layer 104b from conductive layer 104a and/or compromise support structures 112.

Thus, advantages of some embodiments of the present disclosure include electromechanical systems having voids that are completely filled using a thermally-stable, self-planarizing, and/or photo-definable material, which may enhance performance and reliability of some electromechanical systems. Thermal stability, in particular, may minimize reliability concerns associated with outgassing and thermal expansion mismatches. In addition, filling voids may enhance structural rigidity and mechanical properties of the posts or vias.

Yet another advantage of some embodiments is the enablement of larger voids, or an increased number of voids. Larger voids can improve the step coverage, which, in the context of DMDs, can yield more reliable mirrors without compromising contrast ratio (due to the larger void surface area to mirror surface area ratio). A further advantage, in some optical applications, is an increase in reflective surface area and reflective surface flatness of electromechanical structures, which may enhance brightness and contrast.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method for filling a void of an electromechanical system, the method comprising:
forming a support layer having the void;
forming a first layer outwardly from the support layer such that a portion of the first layer partially fills the void;
filling a remainder of the void with an inorganic material; and
forming a mirror outwardly from the inorganic material and the conductive layer.

2. The method of claim 1, further comprising curing the inorganic material.

3. The method of claim 2, wherein the cure temperature is less than approximately 200° C.

4. The method of claim 2, further comprising selecting the inorganic material based on its volume change as a result of the curing step.

5. The method of claim 1, further comprising selecting the inorganic material based on a minimal susceptibility to outgas.

6. The method of claim 1, further comprising overfilling the remainder of the void with the inorganic material.

7. The method of claim 1, wherein the inorganic material inherently forms a planar outer surface after completion of the filling step.

8. The method of claim 1, wherein filling a remainder of the void with an inorganic material comprises spinning on a liquid.

9. The method of claim 1, wherein the inorganic material is glass.

10. The method of claim 1, wherein the inorganic material is capable of filling voids having a maximum width of 0.5 μm.

11. The method of claim 1, wherein the first layer is conductive.

12. A electromechanical system device comprising:
a first layer having a via filled by an inorganic material; and
a moveable mirror disposed outwardly from the inorganic material and the first layer.

13. The electromechanical system device of claim 12, wherein the inorganic material is cured.

14. The electromechanical system device of claim 13, wherein the cure temperature is less than approximately 200° C.

15. The electromechanical system device of claim 13, wherein the inorganic material is selected based on its volume change as a result of the curing step.

16. The electromechanical system device of claim 13, wherein the inorganic material is selected based on a minimal susceptibility to outgas.

17. The electromechanical system device of claim 12, wherein the inorganic material is a spin-on liquid glass.

18. The electromechanical system device of claim 12, wherein the via is less than approximately 0.5 μm wide.

19. The electromechanical system device of claim 12, wherein the first layer is conductive.

20. A method of forming a deformable micromirror device comprising:
forming a support layer outwardly from a hinge, the support layer having a void;
forming a first filling layer outwardly from the support layer such that a portion of the first filling layer partially fills the void and couples to the hinge;
filling a remainder of the void with an inorganic material; and
forming a mirror outwardly from the inorganic material and the first filling layer layer; and
removing the support layer.

21. The method of claim 20, wherein the inorganic material is a spin-on glass.

22. The method of claim 20, wherein the void is less than approximately 0.5 μm wide.

23. The method of claim 20, wherein the first filling layer is conductive.
